(19) United States
(12) Patent Application Publication
(10) Pub. No.: US 2002/0059176 A1
(43) Pub. Date: May 16, 2002

(54) Data communication apparatus, method and program for data communication, and computer readable recording medium having the data communication program recorded thereon

(76) Inventor: Masayuki Fujisawa, Nara-shi (JP)

Correspondence Address: BIRCH STEWART KOLASCH & BIRCH, PO BOX 747, FALLS CHURCH, VA, 22040-0747, US

(21) Appl. No.: 09/901,666

(22) Filed: Jul. 11, 2001

(30) Foreign Application Priority Data
Jul. 11, 2000 (JP) 2000-210467

(51) Int. Cl. G06F 7/00

(52) U.S. Cl. 707/1

(57) ABSTRACT

Controlled by a control section, a data communication apparatus carries out the following operations. In the first place, a transmission/reception scheduling section generates schedule data based on a request for obtaining or transmitting data which occurs in off-line operation in which the data communication apparatus is not connected to network, and the transmission/reception scheduling section stores the schedule data in a schedule data storing section. Here, the transmission/reception scheduling section sets the time and date of connection for each schedule data. A data storage/readout section processes the request for obtaining or transmitting data based on the schedule data in on-line operation in which the data communication apparatus is connected to the network. Further, a network connection section can connect the data terminal apparatus to the network to establish on-line operation at specific time and date based on the time and date detected by a timer section. In this way, the data communication apparatus stores the request for obtaining or transmitting data which occurs in off-line operation, the data being stored as a schedule, and the data communication apparatus processes the request at once in the next or subsequent operation.

### FIELD OF THE INVENTION

The invention relates to a data communication apparatus for utilizing hypertext which is dispersed and respectively stored in a computer network such as the Internet, a method and a program for data communication, and a computer-readable recording medium having the data communication program recorded thereon.

### BACKGROUND OF THE INVENTION

FIG. 10 is a block diagram showing an arrangement of a typical data terminal apparatus 80 for utilizing a hypertext stored in a server apparatus S via a network N such as the Internet. The data terminal apparatus 80 is a hypertext browser, wherein a user searches for data linked to data displayed on a hypertext data display section 83 or directly inputs an URL (uniform resource locator) by operating a user input section 81 so as to specify a location of target data in a hypertext data collecting section 82. Then, the hypertext data collecting section 82 obtains the data via the network N from the server apparatus S having the data, and the hypertext data display section 83 displays the data.

FIG. 11 is a block diagram showing an arrangement of a data terminal apparatus 80′, wherein a hypertext data storage/readout section 84 for storing and reading out the hypertext data is added to the data terminal apparatus 80 (see FIG. 10). In the same manner as the user operates the data terminal apparatus 80, the user requests the data terminal apparatus 80′ to display target data by operating the user input section 81, and the hypertext data collecting section 82 obtains the target data via the network N from the server apparatus S, and the hypertext data display section 83 displays the data. At the same time, the hypertext data collecting section 82 sends the data to the hypertext data storage/readout section 84 in the data terminal apparatus 80′, and the hypertext data storage/readout section 84 stores the data. Note that, the hypertext data storage/readout section 84 can collect and store hierarchically various data linked to the data which are displayed as specified by the user, or only the data specified by the user can be collected and stored.

Further, the data terminal apparatus 80′ is provided with a timer section 85, whereby data can be obtained at the time a user specified, and can be stored in the hypertext data storage/readout section 84. The data stored in the hypertext data storage/readout section 84 can be displayed on the hypertext data display section 83 by users' operation.

An apparatus like the data terminal apparatus 80′ employs a technique, whereby the hypertext data are obtained as a file from a server apparatus and are stored locally according to schedule. Some examples of this technique are described in the following publications.

Japan Unexamined Patent Publication No. 161680/1999 (Tokukaihei 11/161680) (published date: Jun. 18, 1999) discloses an apparatus which can store links in a recorded HTML and schedule data for recording, and can identify the links without analyzing data of the HTML, and also can set a schedule only for data that is needed by a user.

Japan Unexamined Patent Publication No. 212995/1999 (Tokukaihei 11/212995) (published date: Aug. 6, 1999) discloses a method and a system, whereby a user at a user's terminal can register data needed to set a schedule such as “where to receive the data”, “when to receive the data”, “whom to transmit the data to” in a transmitting server, and the transmitting server obtains the data, then transmits the data to a transmitted end, based on the schedule data.

Japan Unexamined Patent Publication No. 232302/1999 (Tokukaihei 11/232302) (published data: Aug. 27, 1999) discloses a data retrieval and distributing method and a system apparatus relating to the method, wherein retrieval items can be scheduled in advance at a client terminal when obtaining retrieval data from a data server connected to an internet system, and data relating to the scheduled items can be retrieved at once at certain time intervals from a www server of the internet system to be distributed to the client's terminal.

As mentioned above, the technique whereby data is obtained via the network from the server apparatus according to schedule for obtaining data has been known conventionally. However, switch from off-line operation to on-line operation in utilizing obtained data has not been considered. That is, data could not be obtained at once in on-line operation based on a request for obtaining data which was scheduled in off-line operation automatically.

Also, the hypertext data has a function as a form which has images of textfields or of buttons and the like, whereby a user enters data and transmits the data to the server apparatus via the network. This enables an implementor or a manager of the hypertext data to receive data which the user enters.

However, transmission of this data form to the server apparatus needs to be carried out only in on-line operation. Therefore, existing data terminal apparatuses (browsers) need to be connected to the network at the time when the user tries to transmit data in off-line operation. That is, it was impossible to transmit the data form at once in on-line operation after entering the data in the form in off-line operation.

### SUMMARY OF THE INVENTION

The main object of the present invention is to provide a data communication apparatus, a method and a program of data communication, and a computer-readable recording medium having the data communication program recorded thereon, which stores, as a schedule, request for obtaining or transmitting data which occurs in off-line operation, so as to be capable of processing the request at once in the next or subsequent on-line operation.

A data communication apparatus of the present invention which utilizes hypertext data stored in a server apparatus via a network, in order to achieve the foregoing object, includes schedule generating means for generating and storing schedule data based on a request for obtaining the hypertext data which occurs in off-line operation in which the data communication apparatus is not connected to the network; and schedule processing means for processing the request for obtaining the hypertext data based on the schedule data in on-line operation in which the data communication apparatus is connected to the network.

Further, the data communication method of the present invention is for a data communication apparatus which utilizes hypertext data stored in a server apparatus via a network, and includes a schedule generating step for generating and storing schedule data based on a request for obtaining the hypertext data which occurs in off-line operation in which the data communication apparatus is not connected to the network; and a schedule processing step for processing the request for obtaining the hypertext data based on the schedule data in on-line operation in which the data communication apparatus is connected to the network.

By the arrangement and the method, when a user reads hypertext data stored in the terminal apparatus in off-line operation and tries to display linked data which is not stored in the terminal apparatus, a request for obtaining the data can be stored in schedule data, and can be processed in the next or subsequent on-line operation, instead of connecting to the network immediately.

This allows the request for obtaining data which occurs in off-line operation to be stored as schedule data automatically, and the terminal apparatus need not be connected to the network at the time when the request for obtaining data occurs. Thus, a schedule for collecting the data later from the network can be set easily and unfailingly.

Further, when the terminal apparatus is connected to the network by user's operation or automatic control based on the schedule data generated in off-line operation, the scheduled data can be obtained automatically. Thus, the user can receive and store the requested data unconsciously, easily, and unfailingly.

Further, since a plurality of requests for obtaining data can be stored as schedule data and processed at once in on-line operation, the user need not connect the terminal apparatus to the network consciously and every time, and cost and time for communication can be reduced.

A data communication apparatus of the present invention which utilizes hypertext data stored in a server apparatus via a network includes schedule generating means for generating and storing schedule data based on a request for transmitting data to the server apparatus which occurs in off-line operation in which the data communication apparatus is not connected to the network; and schedule processing means for processing the request for transmitting the data based on the schedule data in on-line operation in which the data communication apparatus is connected to the network.

Further, a data communication method of the present invention is for a data communication apparatus which utilizes hypertext data stored in a server apparatus via the network, and includes a schedule generating step for generating and storing schedule data based on a request for transmitting data to the server apparatus which occurs in off-line operation in which the data communication apparatus is not connected to the network; and a schedule processing step for processing the request for transmitting data based on the schedule data in on-line operation in which the data communication apparatus is connected to the network.

By the arrangement and the method, when a user reads hypertext data stored in the terminal apparatus and tries to transmit data which was entered in a form in off-line operation, a request for transmitting the data can be stored in schedule data, and can be processed in the next or subsequent on-line operation, instead of connecting to the network immediately.

This allows the request for transmitting data which occurs in off-line operation to be stored as schedule data automatically, and the terminal apparatus need not be connected to the network at the time when the data transmitting request occurs. Thus, a schedule for transmitting the data later to the network can be set easily and unfailingly.

Further, when the terminal apparatus is connected to the network by user's operation or automatic control, the schedule data can be transmitted automatically based on the schedule data generated in off-line operation. Thus, the user can transmit the schedule data unconsciously, easily, and unfailingly.

Further, since a plurality of requests for transmitting data can be stored as schedule data, and processed at once in on-line operation, the user need not connect the terminal apparatus to the network consciously and every time, and cost and time for communication can be reduced.

A data communication program of the present invention executable to operate a computer as schedule generating means for generating and storing schedule data based on a request for obtaining the hypertext data which occurs in off-line operation in which the data communication apparatus which utilizes hypertext data stored in a server apparatus via a network is not connected to the network; and as schedule processing means for processing the request for obtaining the hypertext data based on the schedule data in on-line operation in which the data communication apparatus is connected to the network.

By the program, when the user reads hypertext data stored in the terminal apparatus in off-line operation and tries to display linked data which is not stored in the terminal apparatus, a request for obtaining the data can be stored in schedule data, and can be processed in the next or subsequent on-line operation, instead of connecting to the network immediately.

This allows the request for obtaining data which occurs in off-line operation to be stored as schedule data automatically, and the terminal apparatus need not be connected to the network at the time when the request for obtaining data occurs. Thus, a schedule for collecting the data later from the network can be set easily and unfailingly.

A data communication program of the present invention is executable to operate a computer as schedule generating means for generating and storing schedule data based on a request for transmitting data to the server apparatus which occurs in off-line operation in which the data communication apparatus which utilizes hypertext data stored in the server apparatus via the network is not connected to the network; and as schedule processing means for processing the request for transmitting the data based on the schedule data in on-line operation in which the data communication apparatus is connected to the network.

By the program, when a user reads hypertext data stored in the terminal apparatus and tries to transmit data which was entered in a form in off-line operation, a request for transmitting the data can be stored in schedule data, and can be processed in the next or subsequent on-line operation, instead of connecting to the network immediately.

This allows the request for transmitting data which occurs in off-line operation to be stored as schedule data automatically, and the terminal apparatus need not be connected to the network at the time when the data transmitting request occurs. Thus, a schedule for transmitting the data later to the network can be set easily and unfailingly.

A computer-readable recording medium of the present invention records a data communication program which is executable to operate a computer as the schedule generating means for generating and storing schedule data based on a request for obtaining the hypertext data which occurs in off-line operation in which the data communication apparatus which utilizes hypertext data stored in a server apparatus via the network is not connected to the network; and as schedule processing means for processing the request for obtaining the hypertext data based on the schedule data in on-line operation in which the data communication apparatus is connected to the network.

A computer-readable recording medium of the present invention records a data communication program which is executable to operate a computer as the schedule generating means for generating and storing schedule data based on the request for transmitting the data to the server apparatus which occurs in off-line operation in which the data communication apparatus which utilizes hypertext data stored in a server apparatus via the network is not connected to the network; and as the schedule processing means for processing the request for transmitting the data based on the schedule data in on-line operation in which the data communication apparatus is connected to the network.

The data communication program which is read out from the recording medium can realize the data communication apparatus by a computer, thus having the effect of the foregoing data communication processing whereby a request for obtaining or transmitting data which occurs in off-line operation can be stored as a schedule, and can be processed at once in the next or subsequent on-line operation. Besides, the data communication apparatus can be used in any network environment.

Other objects, characteristics and advantages of the present invention will become apparent from the detailed description taken in conjunction with the accompanying drawings.

### BRIEF DESCRIPTION OF THE DRAWINGS

FIG. 1 is a functional block diagram showing a schematic structure of a data terminal apparatus according to one embodiment of the present invention.

FIG. 2 is a flowchart showing a process for obtaining hypertext data in the data terminal apparatus shown in FIG. 1, FIG. 2 being connected to FIG. 3 at by connector A.

FIG. 3 is a flowchart showing a process for obtaining hypertext data in the data terminal apparatus shown in FIG. 1, FIG. 3 being connected to FIG. 2 by a connector A.

FIG. 4 is a flowchart showing process for transmitting hypertext data in the data terminal apparatus shown in FIG. 1.

FIG. 5 is an example of a list of hypertext data stored in the data terminal apparatus of FIG. 1.

FIG. 6 is an example of a list of schedule data generated in accordance with requests for obtaining and transmitting data which occurs in the data terminal apparatus shown in FIG. 1.

FIG. 7 is an example of an entered data of a form stored in the data terminal apparatus of FIG. 1.

FIG. 8 is an example of a form displayed in the data terminal apparatus of FIG. 1, showing a state in which data is entered.

FIG. 9 is an HTML source displaying the form shown in FIG. 8.

FIG. 10 is a block diagram schematically showing a data terminal apparatus as a conventional hypertext browser.

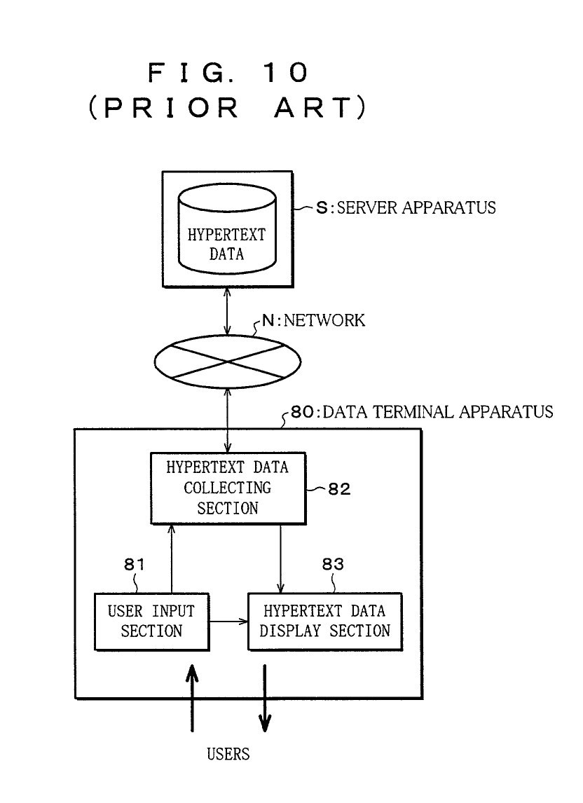

FIG. 11 is a block diagram schematically showing a data terminal apparatus as a conventional hypertext browser.

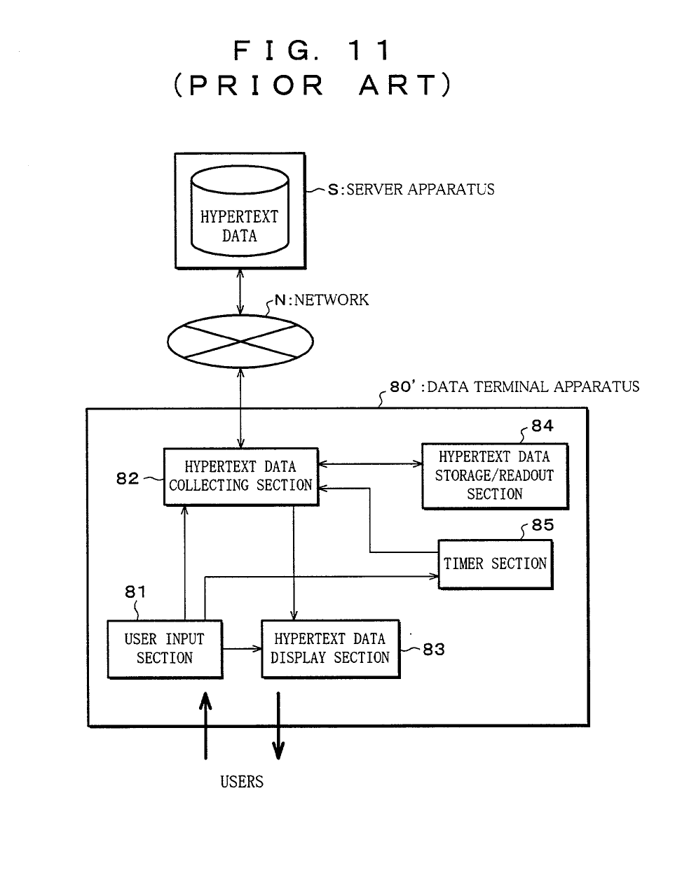

### DESCRIPTION OF THE EMBODIMENTS

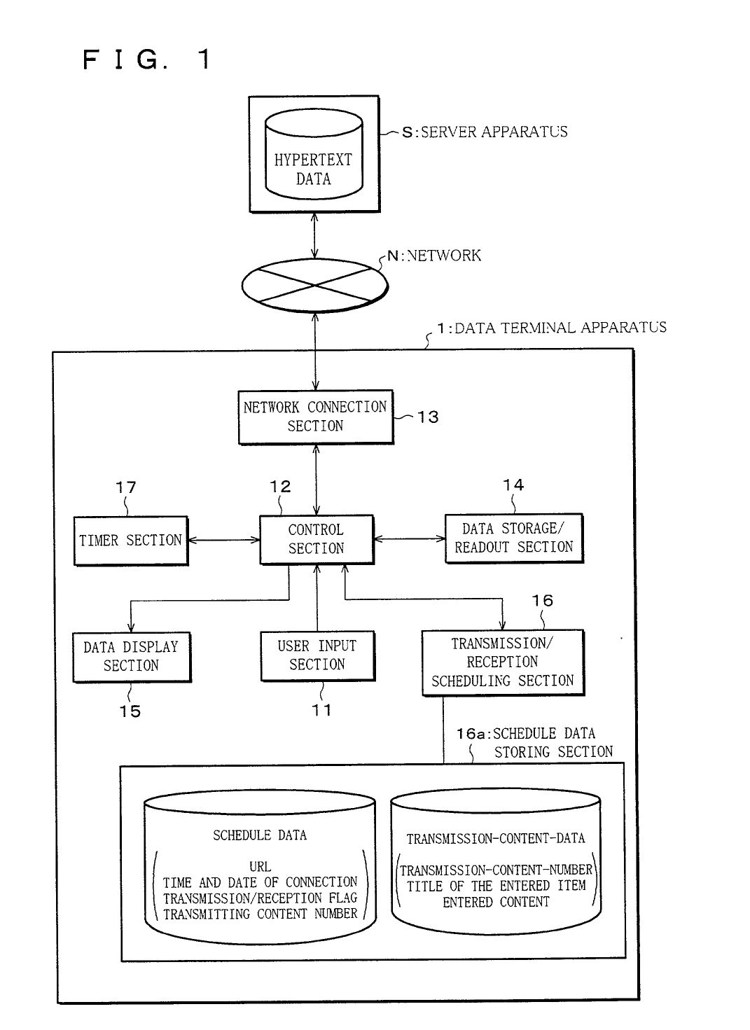

The first embodiment of the present invention is described below, based on FIG. 1 to FIG. 9.

FIG. 1 is a functional block diagram schematically showing a data terminal apparatus (a data communication apparatus) 1 according to the present embodiment. As shown in FIG. 1, the data terminal apparatus 1 is connected via a network N such as the Internet to a server apparatus S where hypertext data is stored. When the hypertext data which the user specified to display is not stored in the terminal apparatus, the data terminal apparatus obtains the data from the server apparatus S and displays the data. The data terminal apparatus 1 also transmits data entered by the user to the server apparatus S.

Note that, the server apparatus S may be singular or plural. Further, the hypertext is, for example, a file system based on HTML (hyper text markup language) in WWW (world wide web) which is a service of the Internet. Hereinafter, the hypertext data may be referred to simply as data where appropriate.

As shown in FIG. 1, the data terminal apparatus 1 includes a user input section 11, a control section (schedule generating means, schedule processing means, connection control means) 12, a network connection section (schedule processing means, connection control means) 13, a data storage/readout section (schedule processing means, data storing means, data readout means) 14, a data display section (data display means) 15, a transmission/reception scheduling section (schedule generating means) 16, and a timer section (clocking means) 17.

The user input section 11 is a user interface, whereby the user operates the data terminal apparatus 1. The user, via the user input section 11, can enter a URL (uniform resource locator) of hypertext data on the network N which the user wants to display, and can anchor in data which is displayed, and can switch from off-line operation to on-line operation (can connect the data terminal apparatus 1 to the network N or disconnect them), and can instruct the terminal apparatus to store data which is displayed or data which is not stored in the terminal apparatus, by obtaining it from the network N. Further, when the timer section 17 is used, it can be instructed to set the time and date of connection, for example.

The network connection section 13 connects to and disconnects from the network N based on instructions of the control section 12, so as to control communication.

The data storage/readout section 14 stores hypertext data which was obtained from the server apparatus S of the network N, based on instructions of the control section 12. Further, the data storage/readout section 14 reads out the hypertext data which is stored in it, so as to reproduce the hypertext data (i.e., an image of the data is formed). The data display section 15 displays the hypertext data which was read out by the data storage/readout section 14, based on instructions of the control section 12. That is, if the hypertext data is HTML format data, the data storage/readout section 14 and the data display section 15 serve the function as an HTML browser.

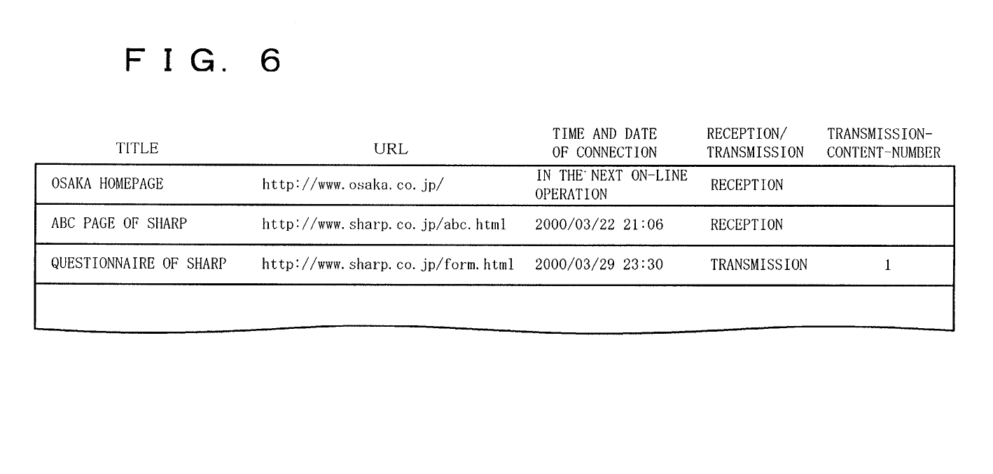

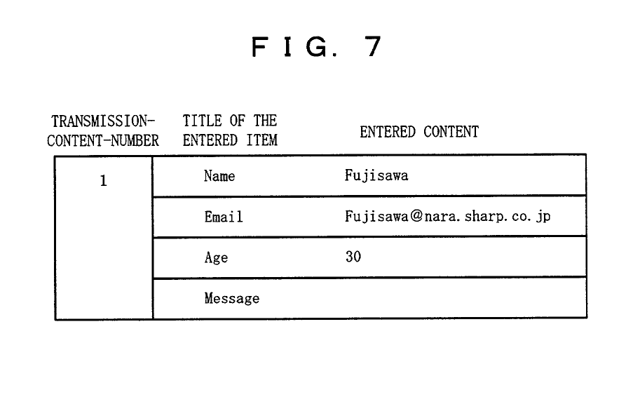

The transmission/reception scheduling section 16 sets a schedule for the request for receiving or transmitting data which occurred in off-line operation, and makes a schedule data storing section (the schedule generating means) 16a store the content of the schedule as the schedule data. In the schedule data (see FIG. 6) are set the URL of the hypertext data, the time and date when the terminal apparatus will be connected to the network N (time and date of connection), and a transmission/reception flag which distinguishes transmission and reception from each other. When the schedule is for data transmission, the content which should be transmitted to the network N is stored as transmission-content data (see FIG. 7). Note that, the schedule data corresponds to the transmission-content data by a transmission-content-number. The schedule data and the transmission-content data may be recorded integrally.

The timer section 17 is a clock which indicates the present time and day.

The control section 12 controls the whole data terminal apparatus 1. When a user, reading hypertext data stored locally in the terminal apparatus (the data storage/readout section 14) in off-line operation, tries to display data which is not stored, the control section 12 instructs the transmission/reception scheduling section 16 to set a schedule for obtaining the data. Further, when the user, reading hypertext data in off-line operation, tries to transmit a data form upon entry, the control section 12 instructs the transmission/reception scheduling section 16 to set a schedule for transmitting the data. The control section 12 processes the transmission and reception of the data scheduled by the transmission/reception scheduling section 16 in the next on-line operation, or at the time when the on-line operation is established by the network connection section 13 based on the scheduled time clocked by the timer section 17 set.

By the arrangement, controlled by the control section 12, the data terminal apparatus 1 works as follows. In the first place, the transmission/reception scheduling section 16 generates schedule data based on a request for receiving or transmitting data which occurs in off-line operation (disconnected from the network N), and the schedule data storing section 16a stores the schedule data. Here, the transmission/reception scheduling section 16 sets the time and date of connection for each schedule data. The data storage/readout section 14 processes the request for receiving or transmitting data based on the schedule data in on-line operation (connected to the network N). Further, the network connection section 13 may establish the on-line operation based on the time and date detected by the timer section 17 by connecting the data terminal apparatus 1 to the network N at this time.

This enables the data terminal apparatus 1 to store the requests for receiving and transmitting data, which occurs in off-line operation, as schedule data, and to process these requests at once in the subsequent on-line operation, which may be the time and date set in the schedule data.

Here, the data terminal apparatus 1 may be based on common computers such as personal computers. That is, the data terminal apparatus 1 includes a CPU (central processing section) for executing a program which realizes its function; a ROM (read only memory) in which a bootlogic is stored; a RAM (random access memory) which develops the program; a storage device (a recording medium) such as a hard disc in which the program and various databases are stored; input devices such as a keyboard and a mouse and the like; output devices such as a monitor, a speaker, and a printer; and a network connection device, for connecting to outside network. All these devices are connected by an internal bus. The functions of the data terminal apparatus 1 are respectively realized by developing the program stored in the storage device on the RAM, and by executing the program by the CPU.

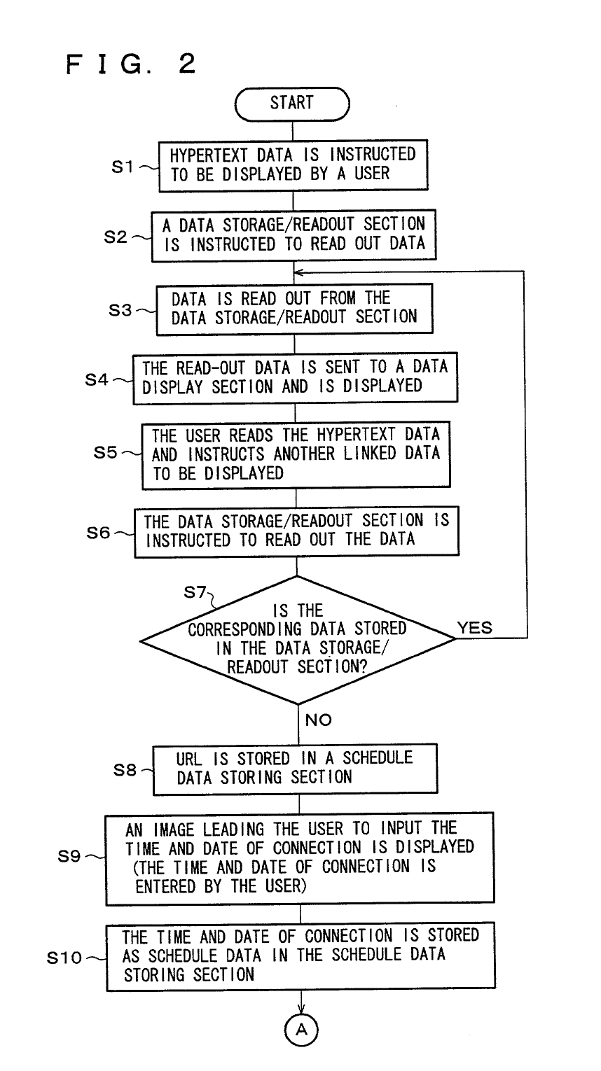

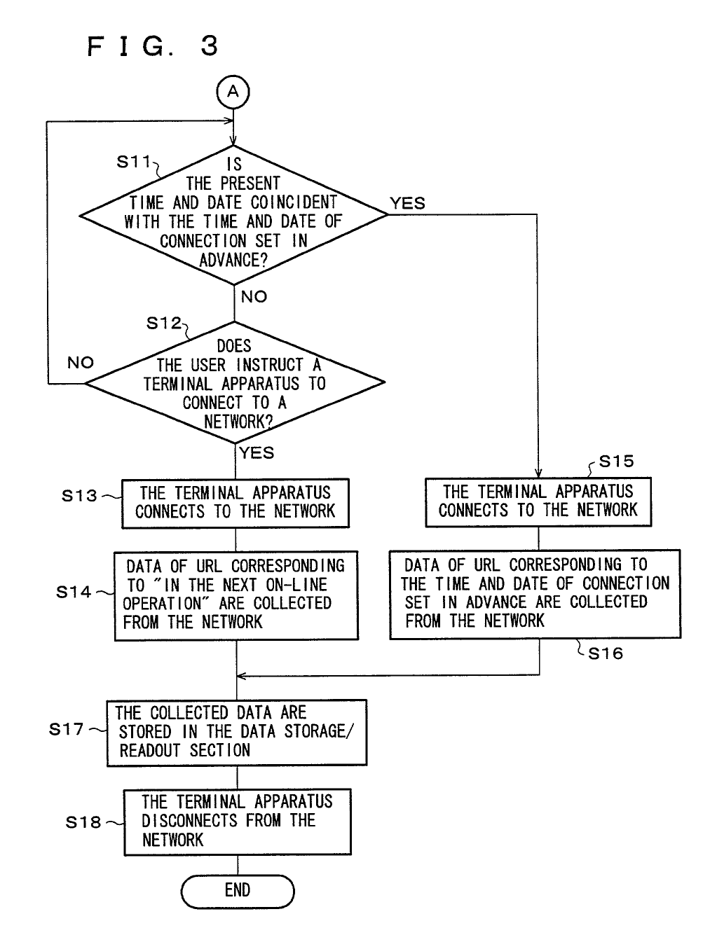

Referring to FIG. 2 and FIG. 3, the following describes in detail operations of generating a schedule of a request for obtaining data and processing a schedule for obtaining data, in which hypertext data, which is not stored in the terminal apparatus (data storage/readout section 14), is obtained and stored. Flowcharts of FIG. 2 and FIG. 3 are connected by a connector A. Also steps S8 to S10 make up a schedule generating step, and steps S13 to S17 make up a schedule processing step.

In step S 1, by operating the user input section 11 in off-line operation the user enters URL of the hypertext page data which the user wants to display, or the user follows a link from the displayed data with a pointing device so as to give hypertext data.

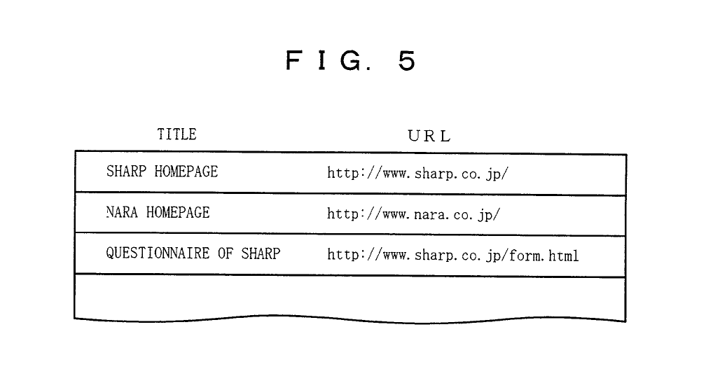

For example, the hypertext data stored in the data storage/readout section 14 is instructed to be displayed by the user in off-line operation. More concretely, for example, as shown in FIG. 5, the user selects “sharp homepage” and the like from a list of hypertext data stored in the data storage/readout section 14 to instruct which data should be displayed.

In step S 2, when the control section 12 receives instructions for displaying data which is stored in the data storage/readout section 14 from the user input section 11, the control section 12 instructs the data storage/readout section 14 to read out the data.

For example, the control section 12 sends URL of “sharp homepage” (http://www.sharp.co.jp/) which was selected from the list in step S 1 (see FIG. 5) to the data storage/readout section 14, and instructs the data storage/readout section 14 to read it out.

In step S 3, when the data storage/readout section 14 receives the instructions for reading out the data, the data storage/readout section 14 retrieves the requested data from the stored data, and reads out the data.

For example, as shown in FIG. 5, three hypertext data (“sharp homepage”, “nara homepage”, and questionnaire of sharp”) have already been obtained from the network N, and have already been stored in the data storage/readout section 14. Thus, the data storage/readout section 14 retrieves the data of URL (http://www.sharp.co.jp/) given in step S 2 from the stored data, and reads out the data (“sharp homepage”).

In step S 4, when the control section 12 receives the read out data from the data storage/readout section 14, the control section 12 sends the data to the data display section 15, and the data is displayed on the data display section 15.

For example, the data (“sharp homepage”) of URL (http://www.sharp.co.jp) specified in step S2 is read out in the data storage/readout section 14, and the data is sent to the data display section 15 by the control section 12 and displayed on the data display section 15.

In step S 5, the user reads data displayed on the data display section 15, and gives instructions for the display of data linked to the displayed data by operating the user input section 11.

For example, the user gives instructions for the display of the linked data (“sharp homepage” (http://www.sharp.co.jp/abc.html)) by using a pointing device according to an anchor on the displayed data.

In step S 6, when the control section 12 receives the instructions for displaying the linked data from the user input section 11, the control section 12 instructs the data storage/readout section 14 to read out the corresponding data.

For example, the control section 12 sends the URL (http://www.sharp.co.jp/abc.html) which was specified in step S 5 to the data storage/readout section 14, and instructs the data storage/readout section 14 to read it out.

In step S 7, when the data storage/readout section 14 receives the instructions for reading out the data, the data storage/readout section 14 retrieves the corresponding data from the stored data, and judges whether the data is stored or not. Thereafter, if stored (YES), the sequence goes to step S 3, and if not stored (NO), the sequence goes to step S 8.

For example, when the data storage/readout section 14 is instructed to read out the data (“abc page of sharp”) in step S 6, the data storage/readout section 14 judges whether the data is stored or not in the stored data (see FIG. 5). In this case, the data is not stored, and the sequence goes to step S 8. If stored, the sequence goes to step S 3.

In step S 8, since the data storage/readout section 14 does not store the data (NO in S 7), the control section 12 receives a request for obtaining data in off-line operation, and instructs the transmission/reception scheduling section 16 to generate a schedule for obtaining data from the URL and to store the data as schedule data in the schedule data storing section 16a.

Here, in step S 9, the control section 12 displays on the data display section 15 an image for entry of the time and date for establishing on-line operation by making a connection to the network N so as to obtain the data, allowing the user to make entry of the time and date. In step S 10, the transmission/reception scheduling section 16 stores the time and date of connection which was entered through the user input section 11 by the user. The time and date is stored in the schedule data stored in step S 8, corresponding to the URL.

For example, as shown in FIG. 6, the transmission/reception scheduling section 16 generates the schedule data for obtaining the data “abc page of sharp”, and stores the URL (http:// www.sharp.co.jp/abc.html) and the like. Thereafter, the control section 12 displays an image for requesting the user to entry the time and date for connecting to the network N in order to obtain the data, and stores the entered time and date (2000/03/22/21:06) in the schedule data.

Here, FIG. 6 is an example of the schedule data which is stored in the schedule data storing section 16a by the transmission/reception scheduling section 16. As shown in FIG. 6, the schedule data has a title, URL, time and date of connection, classification of reception or transmission, and the transmission-content-number.

Concretely, in the schedule data for obtaining the data “abc page of sharp”, URL (http://www.sharp.co.jp/abc.html) and the time and date of connection (2000/03/22/21:06) are set. Since these are for obtaining data, these data are categorized into “reception”.

Note that, the transmission-content-number (mentioned later) is not given to the schedule data for receiving data. Thus, this schedule data indicates that when the timer section 17 tells 2000/03/22/21:06, the network connection section 13 is connected to the network N under the control of the control section 12 to establish on-line operation, and the terminal apparatus receives the data “abc page of sharp” of the URL (http://www. sharp.co.jp.abc.html) . Note that, when the data is to be obtained at the time of next connection, the time and date of connection may be designated as “in the next on-line operation” without specifying time and date.

Thereafter, in step S 11 and step S 12, the control section 12 monitors the timer section 17 and the user input section 11, and judges whether the terminal apparatus should be connected to the network N or not to establish on-line operation.

That is, in step S 11, the control section 12 judges whether the time and date indicated by the timer section 17 became the time and date of connection which is stored in the transmission/reception scheduling section 16. Here, when any of the time and date of connection which is stored in the schedule data comes (YES), the sequence goes to step S 15. When the time and date of connection does not come (NO), the sequence goes to step S 12.

Then, in step S 12, the control section 12 judges whether instructions for connecting to the network N to establish on-line operation was given by the user or not. When the instructions are given (YES), is chosen, the sequence goes to step S 13. When the instructions are not given (NO), the judgement process from step S 11 is repeated.

For example, in the case where the three schedule data shown in FIG. 6 are stored, when the data terminal apparatus 1 is not connected to the network N and is in off-line operation until the time and date for obtaining the data “abc page of sharp” (2000/03/22/21:06), (NO) is chosen in both step S 11 and step S 12, and the judgement process described above is repeated.

Thereafter, when instructions for connecting to the network N is given by the user (in step S 12, YES is chosen), in step S 13, the control section 12 instructs the network connection section 13 to connect to the network N, so as to establish on-line operation. In step S 14, the control section 12 collects from the network N the data of URL which is indicated by “in the next on-line operation” among the schedule data which are stored in the data transmission/reception scheduling section 16, and the sequence goes to step S 17.

For example, in the schedule data shown in FIG. 6, since the date and time of connection for the schedule data of the “osaka homepage” stored in the schedule data storing section 16a is “in the next on-line operation”, this data is collected from the network N.

When the timer section 17 tells the scheduled time and date of connection (in step S 11, YES is chosen), in step S 15, the control section 12 instructs the network connection section 13 to connect to the network N to establish on-line operation.

In step S 16, the control section 12 collects data of the schedule data which is stored in the transmission/reception/data scheduling section 16 having the time and date as indicated by the timer section according to the judgement in step S 11, the data being collected according to its URL from the network N, and the sequence goes to step S 17.

For example, in the schedule data shown in FIG. 6, the time and date of the schedule data is “b 2000/03/22 21:16”, which is the same time and date as judged by the timer section 17 in step S 11, and the data “abc page of sharp” is collected from the network N.

Finally, the control section 12 makes the data storage/readout section 14 store the collected data (S17), and makes the network connection section 13 disconnect from the network N to establish off-line operation (S18).

Thus, in the data terminal apparatus 1, when hypertext data which was collected in a local device such as a disc or a memory is read by the user in off-line operation and the user performs an anchoring operation to display another data linked to the data which is not stored locally, a schedule for obtaining and storing the data locally is set, instead of connecting to the network N immediately.

This enables the user to obtain the scheduled data unconsciously and automatically, when the next connection to the network N is made by the user's operation. Further, this also enables the user to obtain the scheduled data unconsciously by automatically making a connection to the network N at the specific time and date according to the timer function.

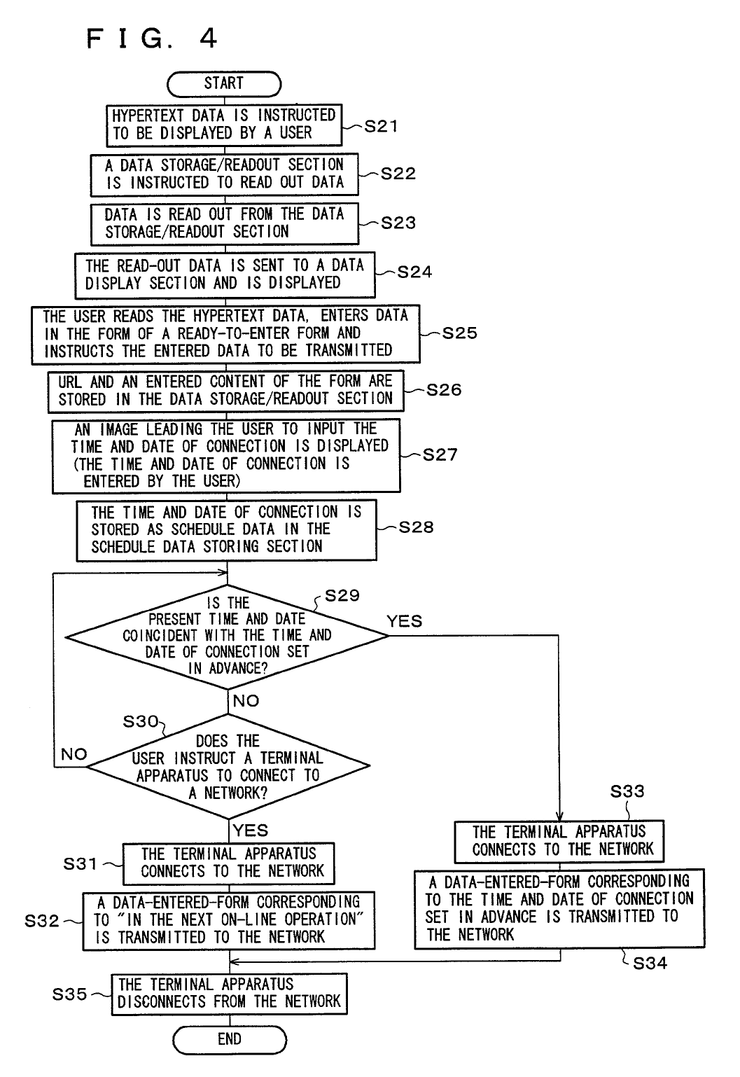

Referring to FIG. 4, the following describes in detail operations of generating and processing a schedule for obtaining, in which data entered by the user in form data stored in the apparatus (the data storage/readout section 14) in the data terminal apparatus 1 is transmitted. Steps S 26 to S 28 make up a schedule generating step, and steps S 31 to S 34 make up a schedule processing step.

In the first place, in steps S 21 to S 24, in the same way as in steps S 1 to S 4 (see FIG. 2), data to be used for the form entry is read out from the hypertext data stored in the data storage/readout section 14 in off-line operation, and is displayed on the data display section 15.

For example, “questionnaire of sharp” selected from the list (see FIG. 5) by the user is read out by the data storage/readout section 14, and is displayed on the data display section 15.

Next, in step S 25, the user reads data of the ready-to-enter form displayed on the data display section 15, and inputs data, and requests the content of the data to be transmitted after data entry by operating the user input section 11.

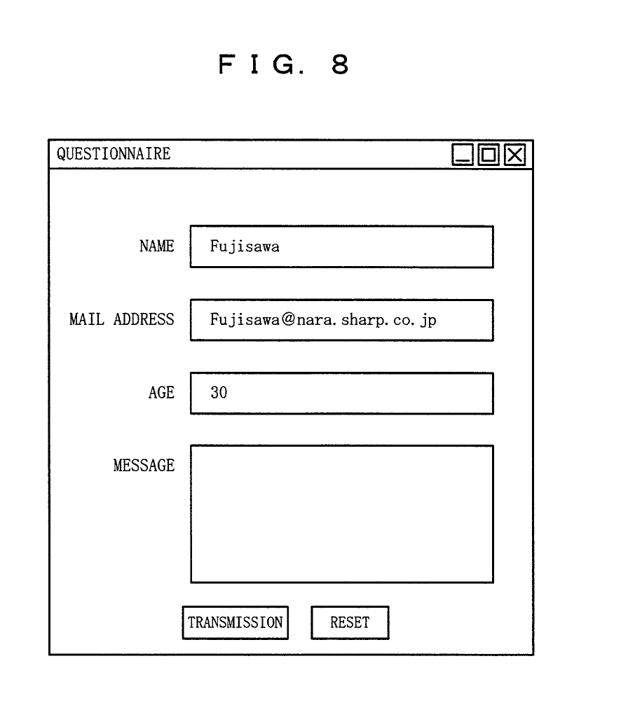

For example, as shown in FIG. 8, the user fills in the form of the displayed data (“sharp homepage”) by using a pointing device or a keyboard, and requests the entered data to be transmitted by pushing a transmission button displayed on the screen.

In step S 26, when the control section 12 receives the request for transmitting the data which was entered in the form by operating the user input section 11 in off-line operation, the control section 12 instructs the transmission/reception scheduling section 16 to generate a schedule, for transmitting the data-entered-form (transmission-content). In response to the instructions, the transmission/reception scheduling section 16 stores URL of the displayed data and its transmission-content in the schedule data storing section 16a, as schedule data and as transmission-content data, respectively.

Here, in step S 27, the control section 12 shows a display on the data display section 15 for the entry of the time and date of connection to the network N to establish on-line operation to transmit the content of the entered form, thereby allowing the user to fill in the form. In step S 28, the transmission/reception scheduling section 16 stores the time and date of connection which was entered by the user through the user input section 11, the time and date being stored in the schedule data which was stored in step S 26, corresponding to the URL and the transmission-content. When the time and date of connection is not specified, and the user wants to obtain the data at the time of next connection, the time and date of connection may be set to “in the next on-line operation”.

For example, as shown in FIG. 6, the transmission/reception scheduling section 16 generates schedule data for transmitting the content of an entered form (transmission-content) for “questionnaire of sharp”, and stores URL (http://www.sharp.co.jp/form.html) and the content-number which indicates the content of the entered form to be transmitted. Further, as shown in FIG. 7, the transmission/reception scheduling section 16 stores the content of the entered form in the form entry item titles and entry contents in the HTML in pair, together with the transmission-content-number which indicates the content of this data was entered for the “questionnaire of sharp” (http:www.sharp. co.jp/form.html).

In this way, the transmission/reception scheduling section 16 stores the content of the entered data corresponding to the schedule data so that the data for which the stored content of the entered form was entered can be identified. Then, the control section 12 shows a display, asking the user to enter the time and date of connection for transmitting the data to the network N, and stores the entered time and date in the schedule data.

As mentioned above, the schedule data (see FIG. 6) which is stored in the schedule data storing section 16a by the transmission/reception scheduling section 16 includes a title, URL, the time and date of connection, classification of transmission/reception, and transmission-content-number.

Concretely, the schedule data for transmitting the content of the entered form for the “questionnaire of sharp” includes URL (http://www.sharp.co.jp/form.html) and the time and date of connection (2000/03/29 23:30), as well as its title. Since this is data transmission, this is classified as “transmission” in the classification of transmission/reception. Moreover, a transmission-content-number “1” which indicates a data part of the content of the entered form, which is stored separately from the schedule data is given.

Thus, by the schedule data, the network connection section 13 is connected to the network N to establish on-line operation under the control of the control section 12 when the timer section 17 tells Mar., 29, 2000, 23:30, i.e., the time and date of connection, and the data which has been entered in the form in advance and is managed according to the transmission-content-number “1” is transmitted to “questionnaire of sharp” shown by the URL (http://www.sharp.co.jp/form.html).

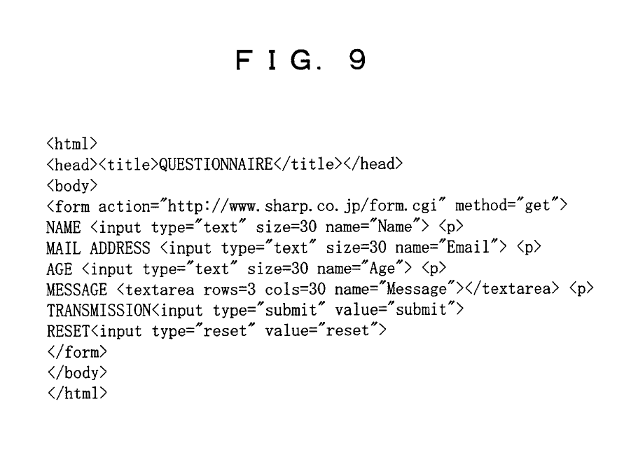

Here, FIG. 8 is an example of a displayed page based on the hypertext data of the HTML format shown in FIG. 9, showing how the form is filled in. When the user pushes a transmission button in this state, entered content of each item as well as the title of the corresponding item is recorded in the transmission-content-data (see FIG. 7). The transmission-content-number “1” which indicates the data-entered “questionnaire of sharp” is given to the transmission-content-data, together with the schedule data (see FIG. 6).

In steps S 29 and step S 30, the control section 12 monitors the timer section 17 and the user input section 11, and judges whether on-line operation should be established by connecting to the network N.

That is, in step S 29, the control section 12 judges whether the time and date set in the timer section 17 are coincident with the time and date of connection of the schedule data stored in the transmission/reception scheduling section 16. Here, when the time and date of connection of any schedule data are coincident with the present time and date (YES), the sequence goes to step S 33, and when it is not (NO), the sequence goes to step S 30.

In step S 30, the control section 12 judges whether the user has entered instructions for connecting the terminal apparatus to the network N to establish on-line operation. When the instructions are given (YES), the sequence goes to step S 31, and when it is not (NO), the sequence goes to step S 29 to repeat the judgement process.

For example, when the three schedule data shown in FIG. 6 are stored and the data terminal apparatus 1 is in off-line operation and is not connected to the network N until the time and date of connection (Mar., 29, 2000, 23:30) for transmitting the content of the entered form for “questionnaire of sharp”, steps S 29 and step S 30 are NO, and the judgement process is repeated.

When the user enters instructions for connecting the terminal apparatus to the network N (in step S 30, YES), in step S 31, the control section 12 instructs the network connection section 13 to connect to the network N to establish on-line operation. In step S 32, the control section 12 reads out stored data of URL whose time and date of connection is “in the next on-line operation” among the schedule data stored in the schedule data storing section 16a from the data storage/readout section 14, and the content of the entered form corresponding to the data is read out from the schedule data storing section 16a and is synthesized with the data and transmitted to the network N.

Note that, in the schedule data shown in FIG. 6, since there is no schedule data in the schedule data storing section 16a whose time and date of connection is “in the next online-operation”, no data is transmitted to the network N.

When the timer section 17 indicates the time and date of connection set in the schedule data (in step S 29, YES), in step S 33, the control section 12 instructs the network connection section 13 to connect to the network N to establish on-line operation. In step S 34, the control section 12 reads out stored data of URL whose time and date of connection is indicated by the timer section 17 as judged in step S 29, among the schedule data stored in the transmission/reception scheduling section 16, and the content of the entered form corresponding to the data is read out from the schedule data storing section 16a, synthesized with the data, and transmitted to the network N.

For example, in the schedule data shown in FIG. 6, the data of “the questionnaire of sharp” which is stored in the data storage/readout section 14 with the schedule data having the time and date of connection “2000/03/29/23:30”, as indicated by the timer section 17 in step S 29, is read out, and the content of the entered form corresponding to the data is read out from the schedule data storing section 16a, synthesized with the data, and transmitted to the network N.

Finally, in step S 35, the control section 12 instructs the network connection section 13 to disconnect from the network N to establish off-line operation.

Here, regardless of whether the data terminal apparatus 1 is in on-line operation or off-line operation, the schedule data (FIG. 6) can be displayed on the data display section 15 in the form of a list or of an individual item to allow the user to confirm setting or re-enter the time and date of connection or cancel the schedule.

Thus, in the data terminal apparatus 1, when the hypertext data being read in off-line operation is form-data which can be entered by the user and when the user tries transmit the form-data which was entered in off-line operation, instead of connecting to the network N immediately to establish on-line operation, the data terminal apparatus 1 stores the transmission-content locally, for example, in a disc or a memory temporarily, then it sets a schedule for transmitting the content.

This enables the user to automatically and unconsciously transmit the data of transmission-content which was scheduled to be transmitted at the time when the user makes the next connection to the network N. Further, this also enables the user to unconsciously transmit data which was scheduled to be transmitted, by automatically connecting to the network N at specific time and date according to the timer function.

Note that, the invention is to be considered in all respects as illustrative and not restrictive, and may be embodied in other specific forms without departing from the scope of the appended claims thereof.

For example, in the present embodiment, in steps S 32 and 34 (FIG. 4), the HTML data of a form is synthesized with the content of the entered form, so as to transmit the data entered in the form to the network N by the user. This enables the URL of the receiving end to be obtained from the HTML, and enables encoding of the content of the entered form for transmission and the transmitting process to be carried out with the conventional browser's function.

Alternatively, the URL of the receiving end may be stored in the schedule data storing section 16a by including it in the schedule data, and encoding of the content of the entered form and the transmitting process may be carried out by the control section 12, instead of the conventional browser's function. This enables the HTML of the form and the content of the entered form to be transmitted without the synthesizing process.

As mentioned above, a data communication apparatus (a data terminal apparatus 1) according to the invention may include: a user input section (a user input section 11) which a user operate to use hypertext data; a hypertext data display section (a data display section 15), for displaying the hypertext data; a hypertext data storage/readout section (a data storage/readout section 14) for locally storing the hypertext data on the side of the user's terminal as well as reading the data; a transmission/reception schedule data storing section (transmission/reception scheduling section 16) for storing, if data which is not stored in the hypertext data storage/readout section is requested to be displayed by the user, the URL of the data, and the time and date of connection to the network, and storing, and a form when the user has requested transmission of the content of the form which he/she entered through the user input section to the network, the content to be transmitted; a network connection section (network connection section 13) which connects the terminal apparatus to the network; and a control section (control section 12) which controls the whole terminal apparatus. The data communication apparatus may further include a timer section (timer section 17) which manages the time of the terminal apparatus as a whole.

Concretely, the data communication apparatus, in an apparatus such as a data processing apparatus which utilizes hypertext data in which a location of a file (link) to be referred to is provided in text data, and the file can be referred to by specifying the link, and also can be linked to another data, may includes: a user input section which the user operates to use the hypertext data; a hypertext data display section for displaying the hypertext data; a hypertext data storage/readout section for locally storing the hypertext data on the side of the user's terminal and for reading out the data; a transmission/reception schedule storing section for storing, if data which is not stored in the hypertext data storage/readout section is requested to be displayed by the user, the URL of the data, and the time and date of connection to the network, and storing, and a form when the user has requested transmission of the content of the form which he/she entered through the user input section to the network, the content to be transmitted; a network connection section which connects the terminal apparatus to the network; a control section which controls the whole body of the terminal apparatus, wherein when the user instructs the hypertext data display section to display the hypertext data which is not stored in the hypertext data storage/readout section by operating the user input section, and when the data is not stored in the hypertext data storage/readout section, the control section controls the transmission/reception schedule data storing section to store the URL so as to store the data.

Therefore, when the hypertext data which has been obtained already in the apparatus is read by the user in off-line operation and the user tries to display another data which is not stored in the apparatus and linked to the data by anchoring, a schedule for collecting the data later from the network can be set easily and with certainty, without connecting to the network immediately. Further, the requested data can be stored easily without fail based on the schedule.

Further, the data communication apparatus may be adapted so that, when the user instructs the data which is stored in the hypertext data storage/readout section to be displayed on the hypertext data display section by operating the user input section, and when the user gives instructions, when the data is hypertext data in the form of a ready-to-enter form for transmitting the data, the control section controls the transmission/reception schedule data storing section to store the transmission-content.

Therefore, when the hypertext data which was obtained from the network and stored in advance in the apparatus is read by the user in off-line operation, and when the user gives instructions, when the data is hypertext data in the form of a ready-to-enter form for transmitting the data, the transmission-content is stored instead of connecting to the network immediately and a request for transmitting the data to the network later can be set easily without fail. Further, the requested data can be transmitted easily and unfailingly according to the schedule.

Further, the data communication apparatus may be adapted so that the control section controls the network connection section to collect data from the URL stored in the transmission/reception schedule data storing section, or to transmit the content of the entered form at the time of the next connection to the network.

Therefore, the hypertext data is stored and the content of the entered form is transmitted at once automatically in the next on-line operation. Thus, the user need not connect the terminal apparatus to the network every time, and the data can be transmitted or received unconsciously, and cost and time for communication can be reduced.

Further, the data communication apparatus may be adapted so that the control section controls the network connection section to collect data from the URL stored in the transmission/reception schedule data storing section, or to transmit the content of the entered form when the data communication apparatus is connected to the network at the time when the timer section indicates the time and date of connection which is stored in the transmission/reception schedule data storing section.

Therefore, by using the timer function, the hypertext data can be stored or the content of the entered form can be transmitted automatically while the user is out or sleeping at a specified time and date, or when the next connection to the network is made. Thus, cost and time for communication can be reduced.

Finally, the present invention may be applied to a system made up of a plurality of devices (for example, a host computer, a terminal computer, an interface device, a network device, a reader, a printer and the like), or to an apparatus made up of single device (for example, a portable computer, a word processor and the like).

Further, the object of the present invention can also be achieved by providing the system or apparatus with a computer-readable recording medium which records the data communication program which is a software for realizing the foregoing functions, that is, a program code of a data obtaining program and a data transmitting program (an execute form program, an intermediate code program, a source program), and by recording and executing the program code recorded in the recording medium, by a computer (or CPU or MPU) of the system or the apparatus. In this case, the program code itself which is read from the recording medium realizes the foregoing functions, and the recording medium in which the program code is recorded comprises the present invention.

The recording medium for providing the program code can be provided separately for the system and the apparatus. Further, the recording medium may be a medium which holds the program code fixedly to provide the program code. Further, the recording medium may be installed in the system or the apparatus so that the program code recorded in it can be read by a computer directly, or the recording medium may be provided so that the program code can be read via a device for reading the program which is connected to the system or the apparatus as an external storage device.

Examples of the recording medium include: tapes such as a magnetic tape and a cassette tape, discs including a magnetic disc such as a floppy disc/a hard disc, and an optical disc such as CD-ROM/MO/MD/DVD/CD-R and the like; cards such as an IC card (including a memory card)/an optical card and the like; and semiconductor memories such as a mask ROM/EPROM/EEPROM/flash ROM and the like.

Further, the program code may be recorded so that a computer can read it from the recording medium to directly execute it, or may be recorded so that it is read out from a main memory by a computer and executed after being transferred from the recording medium to a program memory area in the main memory.

Moreover, the recording medium may a medium which carries the program code fluidly so that it can provide the program code via a communication network and the like. In this case, the system or the apparatus is adapted so that it can be connected to a communication network (including the Internet or an intranet and the like), and the program code can be provided by down loading it from the communication network.

Note that, a program for reading the program code from the recording medium to store the program code in the main memory, and a program for down loading the program code from the communication network are installed in the system or the apparatus in advance to be executable by a computer.

The foregoing functions can be realized, not only by executing the program code read by the computer, but also by an OS and the like operating a computer, carrying out the task partly or wholly, based on the instructions of the program code.

Moreover, the foregoing functions can also be realized in the following way. The program code read from the recording medium is written on a memory which is provided on a feature-expanded board installed in a computer or a feature-expanded unit connected to a computer, thereafter, a CPU and the like provided on the function-extended board or the function-extended unit carry out the task partly or wholly according to the instructions of the program code.

As mentioned above, the data communication apparatus of the present invention, in a data communication apparatus which utilizes hypertext data stored in a server apparatus via a network, includes schedule generating means for generating and storing schedule data based on a request for obtaining the hypertext data which occurs in off-line operation in which the data communication apparatus which utilizes hypertext data stored in a server apparatus via a network is not connected to the network; and schedule processing means for processing the request for obtaining the hypertext data based on the schedule data in on-line operation in which the data communication apparatus is connected to the network.

Further, the data communication method of the present invention which utilizes hypertext data stored in a server apparatus via a network includes a schedule generating step, for generating and storing schedule data based on a request for obtaining the hypertext data which occurs in off-line operation in which the data communication apparatus is not connected to the network; and a schedule processing step for processing the request for obtaining the hypertext data based on the schedule data in on-line operation in which the data communication apparatus is connected to the network.

According to this arrangement and method, the data communication apparatus, in the first place, takes the schedule generating means (the schedule generating step) for generating and storing schedule data based on the request for obtaining the hypertext data which occurs in off-line operation in which the data communication apparatus is not connected to the network. Then, the data communication apparatus takes a schedule processing means (the schedule processing step) for processing the request for obtaining the hypertext data based on the schedule data in on-line operation in which the data communication apparatus is connected to the network.

Thus, when the user reads hypertext data stored in the terminal apparatus in off-line operation and tries to display linked data which is not stored in the terminal apparatus, a request for obtaining the linked data is stored in schedule data, instead of connecting to the network immediately, so that the data can be processed in the next or subsequent on-line operation.

This allows the request for obtaining data which occurs in off-line operation to be stored as schedule data automatically. Therefore, the terminal apparatus need not be connected to the network at the time when the request for obtaining the data occurs, and a schedule for collecting the data later from the network can be set easily without fail.

Further, since the scheduled data can be obtained automatically when the terminal apparatus is connected to the network by the user's operation or automatic control based on the schedule data generated in off-line operation, the requested data can be stored unconsciously in the apparatus easily and without fail.

Further, since a plurality of requests for obtaining data are stored as schedule data and the schedule data can be processed at once in on-line operation, the user need not connect the terminal apparatuses to the network every time, and cost and time for communication can be reduced.

The data communication apparatus of the present invention which utilizes hypertext data stored in a server apparatus via network, as described above, includes, schedule generating means for generating and storing schedule data based on a request for transmitting data to the server apparatus which occurs in off-line operation in which the data communication apparatus is not connected to the network; and schedule processing means for processing the request for transmitting the hypertext data based on the schedule data in on-line operation in which the data communication apparatus is connected to the network.

And, the data communication method of the present invention includes the schedule generating step for generating and storing schedule data based on a request for transmitting data to the server apparatus which occurs in off-line operation in which the data communication apparatus which utilizes hypertext data stored in a server apparatus via the network is not connected to the network; and the schedule processing step for processing the request for transmitting the data based on the schedule data in on-line operation, in which the data communication apparatus is connected to the network.

According to this arrangement and method, the data communication apparatus, in the first place, takes the schedule generating means (the schedule generating step) for generating and storing schedule data based on the request for transmitting data to the server which occurs in off-line operation in which the data communication apparatus is not connected to the network. Then, the data communication apparatus takes a schedule processing means (the schedule processing step) for processing the request for transmitting the data based on the schedule data in on-line operation in which the data communication apparatus is connected to the network.

Thus, when the user reads hypertext data stored in the terminal apparatus in off-line operation and tries to transmit the data entered in the form, a request for transmitting data is stored in schedule data, instead of connecting to the network immediately so that the data can be processed in the next or subsequent on-line operation.

This allows the request for transmitting the data which occurs in off-line operation to be stored as schedule automatically. Therefore, the apparatus need not be connected to the network at the time when the request for transmitting the data occurs, and a schedule for transmitting data later can be made easily without fail.

Further, since the scheduled data can be transmitted automatically when the terminal apparatus is connected to the network by the user's operation or automatic control based on the schedule data generated in off-line operation, the requested data can be transmitted to the network unconsciously in the apparatus easily and without fail.

Further, since a plurality of requests for transmitting data are stored as schedule data and the schedule data can be processed at once in on-line operation, the user need not connect the terminal apparatuses to the network every time consciously, and cost and time for communication can be reduced. It is preferable that the data communication apparatus further includes the clocking means which detects present time and date, and connection control means which connects the data communication apparatus to the network to establish on-line operation at predetermined time and date in accordance with the time and date detected by the clocking means.

According to this arrangement, the connection control means connects the data communication apparatus to the network at predetermined time and date in accordance with the time and date detected by the clocking means.

Thus, this enables the terminal apparatus to connect to the network at a specific time and date automatically and obtain or transmit the schedule data automatically and unconsciously, for example, while the user is out or sleeping.

It is preferable in the data communication apparatus that in the schedule generating means, the time and date of connection should be set for each schedule data.

According to this arrangement, further, in the schedule generating means, the time and date of connection of the schedule data is set respectively, for the request for obtaining or transmitting data. Thus, the user can set the time and date for processing the schedule data flexibly for each schedule data.

The computer-readable recording medium of the present invention records a data communication program which is executable to operate the data communication apparatus by realizing the foregoing means by a computer.

According to this arrangement, the data communication program read from the recording medium can realize the data communication apparatus on computers, thus having the effect of the data communication apparatus whereby a request for obtaining or transmitting data which occurs in off-line operation can be stored as a schedule, and can be processed in the next or subsequent on-line operation. Besides, the data communication apparatus can be used in any network environment.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A data communication apparatus, which utilizes hypertext data stored in a server apparatus via a network, comprising:
schedule generating means for generating and storing schedule data based on a request for obtaining the hypertext data which occurs in off-line operation in which the data communication apparatus is not connected to the network; and
schedule processing means for processing the request for obtaining the hypertext data based on the schedule data in on-line operation in which the data communication apparatus is connected to the network.

2. The data communication apparatus as set forth in claim 1, comprising:
clocking means which detects present time and date; and
connection control means which connects the data communication apparatus to the network to establish on-line operation at predetermined time and date in accordance with the time and date detected by the clocking means.

3. The data communication apparatus as set forth in claim 1, wherein the schedule generating means set time and date of connection for each schedule data.

4. The data communication apparatus as set forth in claim 1, comprising:
data storing means for storing the hypertext data obtained from the server apparatus;
data reading out means for reading out the hypertext data stored in the data storing means; and
data display means for displaying the hypertext data read out by the data reading out means,
wherein the hypertext data, which was requested to be obtained in the off-line operation is linked with hypertext data which is displayed by the data display means in the off-line operation.

5. A data communication apparatus, which utilizes hypertext data stored in a server apparatus via a network comprising:
schedule generating means for generating and storing schedule data based on a request for transmitting the data to the server apparatus which occurs in off-line operation in which the data communication apparatus is not connected to the network; and
schedule processing means for processing the request for transmitting the data based on the schedule data in on-line operation in which the data communication apparatus is connected to the network.

6. The data communication apparatus as set forth in claim 5 comprising:
clocking means which detects present time and date; and
connection control means which connects the data communication apparatus to the network at predetermined time and date in accordance with the time and date detected by the clocking means.

7. The data communication apparatus as set forth in claim 5, wherein the schedule generating means set time and date of connection for each schedule data.

8. A data communication method for a data communication apparatus which utilizes hypertext data stored in a server apparatus via a network, said method comprising:
a schedule generating step, for generating and storing schedule data based on a request for obtaining the hypertext data which occurs in off-line operation in which the data communication apparatus is not connected to the network; and
a schedule processing step for processing the request for obtaining the hypertext data based on the schedule data in on-line operation in which the data communication apparatus is connected to the network.

9. The data communication method as set forth in claim 8, comprising:
a time and date detecting step for detecting present time and date; and
a connection control step for connecting the data communication apparatus to the network at predetermined time and date in accordance with the time and date detected by the time and date detecting step.

10. The data communication method as set forth in claim 8, wherein said schedule generating step sets time and date of connection for each schedule data.

11. A data communication method for a data communication apparatus which utilizes hypertext data stored in a server apparatus via a network, said method comprising:
a schedule generating step, for generating and storing schedule data based on a request for transmitting data to the server apparatus which occurs in off-line operation in which the data communication apparatus is not connected to the network; and
a schedule processing step for processing the request for transmitting the data based on the schedule data in on-line operation in which the data communication apparatus is connected to the network.

12. The data communication method as set forth in claim 11 comprising:
a time and date detecting step which detects present time and date; and
a connection control step which connects the data communication apparatus to the network at predetermined time and date in accordance with the time and date detected by the time and date detecting step.

13. The data communication method as set forth in claim 11, wherein the schedule generating step set time and date of connection for each schedule data.

14. A data communication program executable to operate a computer as:
schedule generating means, for generating and storing schedule data, based on a request for obtaining the hypertext data which occurs in off-line operation in which a data communication apparatus which utilizes hypertext data stored in a server apparatus via a network is not connected to the network; and
schedule processing means for processing the request for obtaining the hypertext data based on the schedule data in on-line operation in which the data communication apparatus is connected to the network.

15. The data communication program as set forth in claim 14, executable to operate a computer as:
clocking means which detects present time and date; and
connection control means which connects the data communication apparatus to the network to establish on-line operation at predetermined time and date in accordance with the time and date detected by the clocking means.

16. A data communication program executable to operate a computer as:
schedule generating means, for generating and storing schedule data, based on a request for transmitting data to the server apparatus which occurs in off-line operation in which the data communication apparatus which utilizes hypertext data stored in a server apparatus via a network is not connected to the network; and
schedule processing means for processing the request for transmitting the data based on the schedule data in on-line operation in which the data communication apparatus is connected to the network.

17. The data communication program as set forth in claim 16, executable to operate a computer as:
clocking means which detects present time and date; and
connection control means which connects the data communication apparatus to the network at predetermined time and date in accordance with the time and date detected by the clocking means.

18. A computer-readable recording medium recording a data communication program which is executable to operate a computer as:
schedule generating means, for generating and storing schedule data, based on a request for obtaining the hypertext data which occurs in off-line operation in which the data communication apparatus which utilizes hypertext data stored in a server apparatus via a network is not connected to the network; and
schedule processing means for processing the request for obtaining the hypertext data based on the schedule data in on-line operation in which the data communication apparatus is connected to the network.

19. A computer-readable recording medium recording
a data communication program executable to operate a computer as:
schedule generating means, for generating and storing schedule data, based on a request for transmitting data to the server apparatus which occurs in off-line operation in which the data communication apparatus which utilizes hypertext data stored in a server apparatus via a network is not connected to the network; and
schedule processing means, for processing the request for transmitting the data based on the schedule data in on-line operation, when the data communication apparatus is connected to the network.
